(19) United States
(12) Patent Application Publication
(10) Pub. No.: US 2026/0296474 A1
(43) Pub. Date: Oct. 1, 2026

(54) DRIVING ASSISTANCE DEVICE, DRIVING ASSISTANCE METHOD, AND PROGRAM

(71) Applicant: HONDA MOTOR CO., LTD., Tokyo (JP)

(72) Inventors: Shunsuke Michita, Tokyo (JP); Yuko Sugimura, Tokyo (JP); Takuma Kobayashi, Tokyo (JP); Mineyuki Yoshida, Tokyo (JP)

(21) Appl. No.: 19/550,472

(22) Filed: Feb. 26, 2026

(30) Foreign Application Priority Data
Mar. 31, 2025 (JP) 2025-057523

(51) Int. Cl. B60W 50/14; B60W 40/09

(52) U.S. Cl. CPC B60W 50/14; B60W 40/09; B60W 2050/143

(57) ABSTRACT

A driving assistance device comprises a recognition part, a driving controller, a mode determination part, a judgment part, a storage part, and an execution part. The recognition part recognizes a situation around a vehicle. The driving controller controls one or both of acceleration/deceleration and steering of the vehicle. The mode determination part determines a driving mode in which the vehicle travels in any one of a plurality of driving assistance modes in which tasks imposed on a driver of the vehicle differ. The judgment part determines whether or not the driver is complying with a task imposed on the driver. The storage part stores driving characteristics of the driver. When the judgment part determines that the driver is not complying with the task, the execution part sets an activation timing of an alarm based on the driving characteristics and activates the alarm. The execution part analyzes a reaction tendency of behavioral change of the driver after alarm activation.

### CROSS-REFERENCE TO RELATED APPLICATION

Priority is claimed on Japanese Patent Application No. 2025-057523, filed Mar. 31, 2025, the content of which is incorporated herein by reference.

### BACKGROUND OF THE INVENTION

### Field of the Invention

The present invention relates to a driving assistance device, a driving assistance method, and a program.

### Description of Related Art

In recent years, efforts to provide access to sustainable transportation systems that also consider people in vulnerable positions among traffic participants have been intensifying. Toward this realization, focus is being placed on research and development to further improve traffic safety and convenience through research and development related to driving assistance technology. With the spread of automated driving/advanced driving assistance systems, realization of a safe, secure, and comfortable mobility society is expected. However, it has been pointed out that the number of drivers who place excessive trust in, misuse, or abuse safe driving assistance functions is increasing. Therefore, measures are required to have drivers correctly use driving assistance functions.

For example, Patent Document 1 (Japanese Patent No. 6076109) discloses outputting a warning at an appropriate timing considering the influence of driver characteristics on reaction time. Furthermore, Patent Document 2 (Japanese Patent No. 6950432) discloses changing the output mode of an alarm that prompts compliance with traffic regulations in consideration of driver characteristics.

### SUMMARY OF THE INVENTION

However, alarms according to the background art are not necessarily effective. That is, in order to suppress misuse and abuse of automated driving functions, it is preferable to provide the driver with an alarm in a more appropriate mode according to the driving characteristics and the like of the driver.

For the solution of the above problem, the present application aims to provide a driving assistance device, a driving assistance method, and a program capable of suppressing misuse and abuse of automated driving functions more than conventionally. Additionally, it contributes to the development of sustainable transportation systems by extension.

The driving assistance device according to this invention has adopted the following configuration.
(1): A driving assistance device according to one aspect of the present invention comprises a recognition part that recognizes a situation around a vehicle, a driving controller that controls one or both of acceleration/deceleration and steering of the vehicle, a mode determination part that determines a driving mode in which the vehicle travels in any one of a plurality of driving assistance modes in which tasks imposed on a driver of the vehicle differ, a judgment part that determines whether or not the driver is complying with a task imposed on the driver, a storage part that stores driving characteristics of the driver, and an execution part that, when the judgment part determines that the driver is not complying with the task, sets an activation timing of an alarm based on the driving characteristics and activates the alarm, wherein the execution part analyzes a reaction tendency of behavioral change of the driver after alarm activation.
(2): In the aspect of (1) above, alarm information may be stored in the storage part, and the execution part may set a threshold for alarm activation based on an alarm occurrence frequency extracted from the alarm information.
(3): In the aspect of (1) or (2) above, the judgment part may determine whether or not the behavior of the driver has been corrected after alarm activation.
(4): In the aspect of (1) or (2) above, when the execution part analyzes that the reaction of the behavioral change tends to be slow, the execution part may make at least one of a control timing and a control amount of at least one safe driving assistance function different from a normal control timing or a normal control amount for the driver.
(5): In the aspect of (2) above, the execution part may calculate the alarm occurrence frequency based on at least one of time and distance until the behavior of the driver changes.
(6): In the aspect of (1) or (2) above, when it is determined that the driver is not complying with the task, the execution part may execute control to switch the driving mode determined by the mode determination part to a driving mode with restricted functions, and may release the function restriction when a shift lever is positioned in a non-traveling range or a reverse range.
(7): A driving assistance method according to one aspect of the present invention is such that a computer recognizes a situation around a vehicle, controls one or both of acceleration/deceleration and steering of the vehicle, determines a driving mode in which the vehicle travels in any one of a plurality of driving assistance modes in which tasks imposed on a driver of the vehicle differ, determines whether or not the driver is complying with a task imposed on the driver, stores driving characteristics of the driver, when it is determined that the driver is not complying with the task, sets an activation timing of an alarm based on the driving characteristics and activates the alarm, and analyzes a reaction tendency of behavioral change of the driver after alarm activation.
(8): A program according to one aspect of the present invention causes a computer to recognize a situation around a vehicle, control one or both of acceleration/deceleration and steering of the vehicle, determine a driving mode in which the vehicle travels in any one of a plurality of driving assistance modes in which tasks imposed on a driver of the vehicle differ, determine whether or not the driver is complying with a task imposed on the driver, store driving characteristics of the driver, when it is determined that the driver is not complying with the task, set an activation timing of an alarm based on the driving characteristics and activate the alarm, and analyze a reaction tendency of behavioral change of the driver after alarm activation.

According to the aspects from (1) to (8), it is possible to provide a driving assistance device, a driving assistance method, and a program capable of suppressing misuse and abuse of automated driving functions more than conventionally.

### BRIEF DESCRIPTION OF THE DRAWINGS

FIG. 1 is a system configuration diagram of a vehicle system equipped with a driving assistance device according to an embodiment of the present invention.

FIG. 2 is a block diagram showing a detailed configuration of a first controller and a second controller in the driving assistance device.

FIG. 3 is a diagram showing an example of correspondence relationships among driving modes, control states of the own vehicle, and tasks.

FIG. 4 is a flowchart showing an operation of the driving assistance device according to an embodiment of the present invention.

FIG. 5 is a schematic diagram showing an operation of the driving assistance device according to the driving assistance device.

### DETAILED DESCRIPTION OF THE INVENTION

Hereinafter, embodiments of the driving assistance device, the driving assistance method, and the program of the present invention will be described with reference to the drawings.

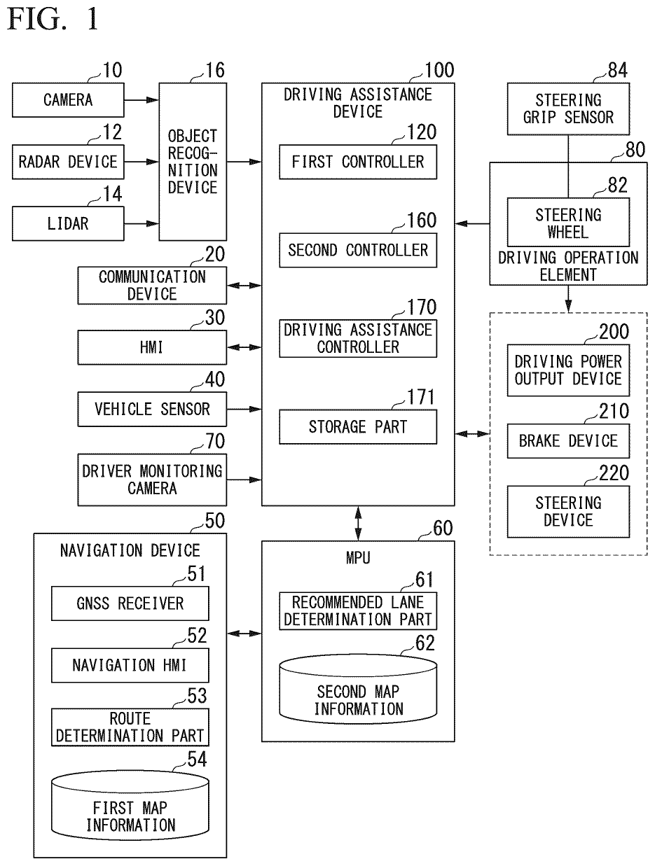

FIG. 1 is a system configuration diagram of a vehicle system equipped with a driving assistance device 100 according to the present embodiment. The vehicle on which the vehicle system is mounted is, for example, a two-wheeled, three-wheeled, four-wheeled, or other vehicle, and its drive source is an internal combustion engine such as a diesel engine or gasoline engine, an electric motor, or a combination thereof. The electric motor operates using electric power generated by a generator connected to the internal combustion engine, or discharge power from a secondary battery or fuel cell.

This vehicle system includes, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, an MPU (Map Positioning Unit) 60, a driver monitor camera 70, a driving operator 80, a driving assistance device 100, a traveling driving force output device 200, a brake device 210, and a steering device 220.

These devices and equipment are connected to each other by multiplex communication lines such as CAN (Controller Area Network) communication lines, serial communication lines, wireless communication networks, and the like. Note that the configuration shown in FIG. 1 is merely an example, and part of the configuration may be omitted, or another configuration may be added.

The camera 10 is, for example, a digital camera using a solid-state imaging element such as a CCD (Charge Coupled Device) or CMOS (Complementary Metal Oxide Semiconductor). The camera 10 is attached to an arbitrary location of the vehicle on which the vehicle system is mounted. When imaging the front, the camera 10 is attached to an upper part of a front windshield, a back surface of a room mirror, or the like. The camera 10, for example, periodically and repeatedly images the periphery of the vehicle. The camera 10 may be a stereo camera.

The radar device 12 radiates radio waves such as millimeter waves to the periphery of the vehicle and detects radio waves (reflected waves) reflected by objects to detect at least the position (distance and direction) of the objects. The radar device 12 is attached to an arbitrary location of the vehicle. The radar device 12 may detect the position and speed of objects by an FM-CW (Frequency Modulated Continuous Wave) method.

The LIDAR 14 irradiates light (or electromagnetic waves with wavelengths close to light) to the periphery of the vehicle and measures scattered light. The LIDAR 14 detects the distance to a target based on the time from light emission to light reception. The irradiated light is, for example, pulsed laser light. The LIDAR 14 is attached to an arbitrary location of the vehicle.

The object recognition device 16 performs sensor fusion processing on detection results input from some or all of the camera 10, the radar device 12, and the LIDAR 14 to recognize the position, type, speed, and the like of objects. The object recognition device 16 outputs the recognition result to the driving assistance device 100. Note that the object recognition device 16 may output the detection results of the camera 10, the radar device 12, and the LIDAR 14 to the driving assistance device 100 as they are. The object recognition device 16 may be omitted from the vehicle system.

The communication device 20, for example, communicates with other vehicles existing around the vehicle using a cellular network, Wi-Fi network, Bluetooth (registered trademark), DSRC (Dedicated Short Range Communication), or the like, or communicates with various server devices via a wireless base station.

The HMI 30 presents various information to occupants of the vehicle and accepts input operations by the occupants. The HMI 30 includes various display devices, speakers, buzzers, touch panels, switches, keys, and the like.

The vehicle sensor 40 includes a vehicle speed sensor that detects the speed of the vehicle, an acceleration sensor that detects acceleration, a yaw rate sensor that detects angular velocity around a vertical axis, a direction sensor that detects the direction of the vehicle, and the like.

The navigation device 50 comprises, for example, a GNSS (Global Navigation Satellite System) receiver 51, a navigation HMI 52, and a route determination part 53. The navigation device 50 holds first map information 54 in a storage device such as an HDD (Hard Disk Drive) or flash memory.

The GNSS receiver 51 specifies the position of the vehicle based on signals received from GNSS satellites. The position of the vehicle may be specified or complemented by an INS (Inertial Navigation System) using the output of the vehicle sensor 40.

The navigation HMI 52 includes a display device, a speaker, a touch panel, keys, and the like. The navigation HMI 52 may be partially or entirely common with the HMI 30 described above.

The route determination part 53, for example, determines a route (hereinafter, route on map) from the position of the vehicle specified by the GNSS receiver 51 (or an arbitrary position inputted) to a destination inputted by an occupant using the navigation HMI 52, with reference to the first map information 54.

The first map information 54 is, for example, information in which a road shape is represented by links indicating roads and nodes connected by the links. The first map information 54 may include road curvature, POI (Point Of Interest) information, and the like. The route on map is output to the MPU 60.

The navigation device 50 may perform route guidance using the navigation HMI 52 based on the route on map. The navigation device 50 may be realized by, for example, the functions of a terminal device such as a smartphone or tablet terminal owned by an occupant. The navigation device 50 may transmit the current position and destination to a navigation server via the communication device 20 and acquire a route equivalent to the route on map from the navigation server.

The MPU 60, for example, includes a recommended lane determination part 61 and holds second map information 62 in a storage device such as an HDD or flash memory.

The recommended lane determination part 61 divides the route on map provided from the navigation device 50 into a plurality of blocks (for example, divides every 100 [m] along the vehicle traveling direction) and determines a recommended lane for each block with reference to the second map information 62. The recommended lane determination part 61 makes a determination such as which lane from the left to travel in. When a branching point exists on the route on map, the recommended lane determination part 61 determines the recommended lane so that the vehicle can travel on a reasonable route to proceed to the branch destination.

The second map information 62 is map information with higher precision than the first map information 54. The second map information 62 includes, for example, information on the center of a lane or information on lane boundaries, and the like. Furthermore, the second map information 62 may include road information, traffic regulation information, address information (address/postal code), facility information, telephone number information, information on prohibited sections where mode A or mode B described later is prohibited, and the like. The second map information 62 may be updated from time to time by the communication device 20 communicating with other devices.

The driver monitor camera 70 is, for example, a digital camera using a solid-state imaging element such as a CCD or CMOS. The driver monitor camera 70 is attached to an arbitrary location in the vehicle at a position and orientation capable of imaging the head of an occupant (hereinafter, driver) seated in the driver's seat of the vehicle from the front (in an orientation that images the face). For example, the driver monitor camera 70 is attached to an upper part of a display device provided in a central part of an instrument panel of the vehicle.

The driving operator 80 includes, for example, a steering wheel 82, an accelerator pedal, a brake pedal, a shift lever, and other operators. A sensor that detects an operation amount or the presence or absence of an operation is attached to the driving operator 80, and the detection result is output to the driving assistance device 100, or to some or all of the traveling driving force output device 200, the brake device 210, and the steering device 220.

The operator does not necessarily have to be annular and may be in the form of a deformed steering, joystick, button, or the like. A steering hold sensor 84 is attached to the steering wheel 82.

The steering hold sensor 84 is realized by a capacitance sensor or the like, and outputs, to the driving assistance device 100, a signal capable of detecting whether or not the driver is holding the steering wheel 82 (meaning being in contact in a state in which force can be applied).

The driving assistance device 100 comprises, for example, a first controller 120, a second controller 160, a driving assistance controller 170, and a storage part 171. The first controller 120 and the second controller 160 are each realized by, for example, a hardware processor such as a CPU (Central Processing Unit) executing a program (software).

Some or all of these components may be realized by hardware (including circuitry) such as LSI (Large Scale Integration), ASIC (Application Specific Integrated Circuit), FPGA (Field-Programmable Gate Array), GPU (Graphics Processing Unit), SOC (System On Chip), or may be realized by cooperation of software and hardware.

The program may be stored in advance in a storage device (a storage device equipped with a non-transitory storage medium) such as an HDD or flash memory of the driving assistance device 100, may be stored in a removable storage medium such as a DVD or CD-ROM, or may be installed in the HDD or flash memory of the driving assistance device 100 when the storage medium (non-transitory storage medium) is attached to a drive device.

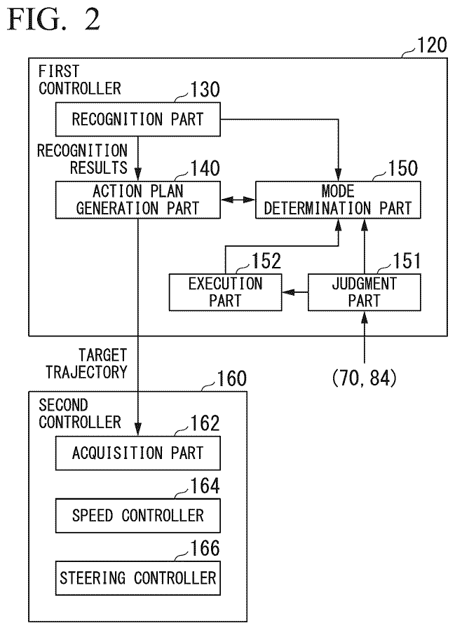

As shown in FIG. 2, the first controller 120 includes, for example, a recognition part 130, an action plan generation part 140, a mode determination part 150, a judgment part 151, and an execution part 152. The first controller 120 realizes, for example, functions by AI (Artificial Intelligence) and functions by a model given in advance in parallel. For example, the function of “recognizing an intersection” may be realized by performing recognition of an intersection by deep learning and the like and recognition based on conditions given in advance (there are signals, road surface markings, etc., that can be pattern-matched) in parallel, and scoring both and comprehensively evaluating them. Thereby, the reliability of automated driving is ensured.

The recognition part 130 recognizes the situation around the vehicle based on information input from the camera 10, the radar device 12, and the LIDAR 14 via the object recognition device 16. That is, the recognition part 130 recognizes states such as the position and speed, acceleration, and the like of objects around the vehicle.

For example, the position of an object is recognized as a position on absolute coordinates with a representative point (such as the center of gravity or drive axle center) of the vehicle as the origin and is used for control. The position of an object may be represented by a representative point such as the center of gravity or corner of the object or may be represented by an area. The “state” of an object may include the acceleration, jerk, or “behavioral state” of the object (for example, whether or not the object is changing lanes or is about to change lanes).

The recognition part 130, for example, recognizes the lane in which the vehicle is traveling (traveling lane), road markings, and the like.

When recognizing the traveling lane, the recognition part 130 recognizes the position and posture of the vehicle with respect to the traveling lane. The recognition part 130 may, for example, recognize the deviation of a reference point of the vehicle from the lane center and the angle formed with respect to a line connecting lane centers in the traveling direction of the vehicle as the relative position and posture of the vehicle with respect to the traveling lane. Instead of this, the recognition part 130 may recognize the position of the reference point of the vehicle with respect to either side end (road marking or road boundary) of the traveling lane as the relative position of the vehicle with respect to the traveling lane.

The action plan generation part 140 generates a target trajectory that the vehicle will automatically travel in the future (without depending on the driver's operation) so as to, in principle, travel in the recommended lane determined by the recommended lane determination part 61 and further avoid approaching objects recognized by the recognition part 130 (excluding passable objects such as road markings, road surface markings, manholes, etc.).

For example, the recognition part 130 sets a risk area centered on an object for which a state has been output, and within the risk area, the recognition part 130 sets a risk as an index value indicating the degree to which the vehicle should not approach.

The action plan generation part 140 generates a target trajectory so that the vehicle does not pass through a point where the risk is equal to or greater than a predetermined value and travels within the recognized traveling lane. Since objects include moving objects, the risk distribution is not just one for each control cycle, but is set for multiple future time points considering the future position of the object predicted based on the speed of the object.

For example, the target trajectory is expressed as a sequence of points (trajectory points) that the vehicle should reach. A trajectory point is a point that the vehicle should reach for each predetermined travel distance (for example, about several [m]) in terms of distance along the road, and separately from that, a target speed and target acceleration for each predetermined sampling time (for example, about several tenths of a second) are generated as part of the target trajectory. Furthermore, a trajectory point may be a position that the vehicle should reach at the sampling time for each predetermined sampling time. In this case, information on target speed and target acceleration is expressed by intervals between trajectory points.

The action plan generation part 140 may set automated driving events when generating a target trajectory. Automated driving events include a constant speed traveling event, a low-speed following traveling event, a lane change event, a branching event, a merging event, a takeover event, and the like. The action plan generation part 140 generates a target trajectory according to the activated event.

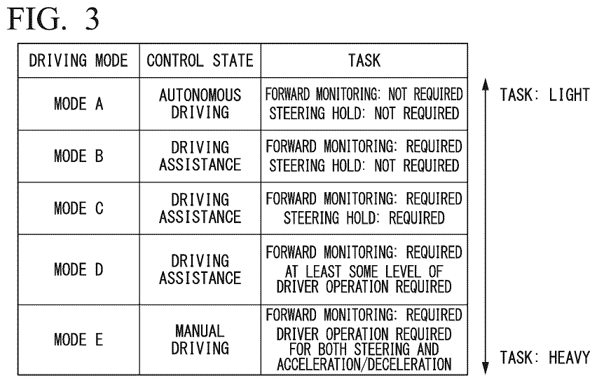

The mode determination part 150 determines a driving mode in which the vehicle travels in any one of a plurality of driving assistance modes in which tasks imposed on the driver of the vehicle differ. The tasks are, for example, forward monitoring by the driver, holding of the steering wheel 82, and the like. FIG. 3 is a diagram showing an example of correspondence relationships among driving modes, control states of the vehicle, and tasks. The driving modes of the vehicle include, for example, five modes from mode A to mode E. The control state, that is, the degree of automation of driving control of the vehicle, is highest in mode A, and becomes lower in the order of mode B, mode C, and mode D and is lowest in mode E.

Conversely, the tasks imposed on the driver are lightest in mode A, become heavier in the order of mode B, mode C, and mode D and are heaviest in mode E. Note that in modes D and E, since the control state is not automated driving, the responsibility of the driving assistance device 100 is to terminate control related to automated driving and shift to driving assistance or manual driving. Hereinafter, the contents of each driving mode are exemplified.

In mode A, a state of automated driving is entered and neither forward monitoring nor holding of the steering wheel 82 (steering hold in the figure) is imposed on the driver. However, even in mode A, the driver is required to be in a posture capable of promptly shifting to manual driving in response to a request from a system centered on the driving assistance device 100. Note that mode A, automated driving, may be included in driving assistance. That is, driving assistance may include automated driving and driving assistance of mode B and below.

Note that automated driving here means that both steering and acceleration/deceleration are controlled without depending on the driver's operation. The front means a space in the traveling direction of the vehicle visually recognized through the front windshield. Mode A is, for example, a driving mode that can be executed when the vehicle is traveling at a predetermined speed (for example, about 50 [km/h]) or less on a motorway such as a highway and conditions such as the existence of a preceding vehicle to be followed are satisfied, and is sometimes referred to as TJP (Traffic Jam Pilot). When this condition is no longer satisfied, the mode determination part 150 changes the driving mode of the vehicle to mode B.

In mode B, a state of driving assistance is entered, and a task of monitoring in front of the vehicle (hereinafter, forward monitoring), but not a task of holding the steering wheel 82 is imposed on the driver. In mode C, a state of driving assistance is entered, and a task of forward monitoring and a task of holding the steering wheel 82 are imposed on the driver. Mode D is a driving mode in which a certain degree of driving operation by the driver is necessary with respect to at least one of steering and acceleration/deceleration of the vehicle.

For example, in mode D, driving assistance such as ACC (Adaptive Cruise Control) and LKAS (Lane Keeping Assist System) is performed. In mode E, a state of manual driving in which driving operation by the driver is necessary for both steering and acceleration/deceleration is entered. In both mode D and mode E, naturally, a task of monitoring in front of the vehicle is imposed on the driver.

Here, the driving mode in the present embodiment is not limited to what is exemplified in FIG. 3, and may be defined by other definitions. For example, among driving modes in which both forward monitoring and steering hold are necessary, there may be one with a lenient threshold and one with a strict threshold for determining that the steering is being held. Furthermore, driving assistance by LKAS (Lane Keeping Assistance System), ACC (Adaptive Cruise Control), ALC (Auto Lane Changing), RDM (Road Departure Mitigation), and CMBS (Collision Mitigation Braking System) may be adopted as driving modes. Each driving assistance will be described later.

More specifically, in a certain driving mode, it is sufficient if either the left or right hand of the driver is touching the steering wheel 82, but in another driving mode in which the tasks imposed on the driver are heavier than that, the driving mode may be defined such that the driver needs to be grasping the steering wheel 82 with both hands with a strength equal to or greater than a threshold. In addition, driving modes in which the severity of tasks imposed on the driver differs may be defined in any manner.

The driving assistance device 100 executes automatic lane change (ALC) according to the driving mode. Automatic lane change includes automatic lane change by system request (1) and automatic lane change by driver request (2).

Automatic lane change (1) includes automatic lane change for overtaking performed when the speed of a preceding vehicle is lower than the speed of the own vehicle by a reference or more, and automatic lane change for proceeding toward a destination (automatic lane change due to a change in the recommended lane).

Automatic lane change (2) is to change the lane of the vehicle in the operation direction when the direction indicator is operated by the driver when conditions related to speed, positional relationship with surrounding vehicles, and the like are satisfied.

The driving assistance device 100, for example, in mode A, executes neither automatic lane change (1) nor (2). The driving assistance device 100, for example, in modes B and C, executes both automatic lane change (1) and (2). The driving assistance device 100, for example, in mode D, does not execute automatic lane change (1) and executes automatic lane change (2). In mode E, for example, neither automatic lane change (1) nor (2) is executed.

The mode determination part 150 determines a driving mode in which the vehicle travels in any one of a plurality of driving assistance modes in which tasks imposed on the driver of the vehicle differ. When a task related to the driving mode determined by the mode determination part 150 itself (current driving mode) is not executed by the driver, the mode determination part 150 may change the driving mode of the vehicle to a driving mode with heavier tasks.

For example, in mode A, when the driver is in a posture incapable of shifting to manual driving in response to a request from the system (for example, when the driver continues looking aside outside a permitted area or when a sign indicating that driving will become difficult is detected), the mode determination part 150 may perform control such as prompting the driver to shift to manual driving using the HMI 30, and pulling the vehicle to the shoulder and gradually stopping it if the driver does not respond, and stopping automated driving. After stopping automated driving, the own vehicle enters a state of mode D or E, and it becomes possible to start the vehicle by manual operation of the driver. Hereinafter, the same applies to “stopping automated driving”.

In mode B, when the driver is not monitoring the front, the mode determination part 150 may perform control such as prompting the driver to perform forward monitoring using the HMI 30, pulling the vehicle to the shoulder and gradually stopping it if the driver does not respond, and stopping automated driving. In mode C, when the driver is not monitoring the front or is not holding the steering wheel 82, the mode determination part 150 may perform control such as prompting the driver to perform forward monitoring and/or hold the steering wheel 82 using the HMI 30, pulling the vehicle to the shoulder and gradually stopping it if the driver does not respond, and stopping automated driving.

ACC (acceleration/deceleration control) is control in which the vehicle automatically controls the speed of the vehicle to follow a preceding vehicle while keeping the distance between the vehicle and the preceding vehicle constant. When there is no preceding vehicle, the speed of the vehicle is controlled so that the vehicle travels at a preset speed.

LKAS (lane keeping control) controls the steering device 220 so that the vehicle does not deviate from the traveling lane. For example, the driving assistance controller 170 controls the steering device 220 so that the vehicle travels at the center or near the center of the traveling lane. Hereinafter, this control may be referred to as “lane keeping control”. The driving assistance controller 170 executes hands-on lane keeping control and hands-off lane keeping control.

Hands-on lane keeping control is control executed in a state where the driver is holding the steering wheel 82 (a state where steering hold sensor 84 detects holding of the steering wheel 82). The conditions under which hands-on lane keeping control can be executed are more lenient than the conditions under which hands-off lane keeping control can be executed. For example, hands-on lane keeping control is executed on the condition that the speed of the vehicle is equal to or higher than a predetermined speed and the driver is monitoring the front.

Hands-off lane keeping control is control executed in a state where the driver is not holding the steering wheel 82 (a state where steering hold sensor 84 does not detect holding of the steering wheel 82). Hands-off lane keeping control can be executed, for example, when the following conditions are satisfied. The speed of the vehicle is equal to or higher than a predetermined speed, the vehicle is traveling on a predetermined road (for example, a road or a type of road preset as being capable of executing hands-off lane keeping control), and the driver is monitoring the front. When the driver is monitoring the front, hands-off lane keeping control is executed, and when the driver is not monitoring the front, hands-off lane keeping control is not executed or is stopped.

The conditions under which the above-described hands-on lane keeping control and hands-off lane keeping control can be executed are examples, and may include other conditions (for example, the vehicle is following a preceding vehicle) or some conditions may be omitted. The conditions under which hands-on lane keeping control can be executed may be more lenient than the conditions under which hands-off lane keeping can be executed (the conditions under which hands-off lane keeping control can be executed may be stricter than the conditions under which hands-on lane keeping can be executed).

RDM is control that, when the vehicle deviates from the traveling lane, performs notification control to the driver, performs reaction force control to give reaction force to the driver's operation of the steering wheel 82 in a direction that would cause deviation from the traveling lane, or performs steering control so that the vehicle moves in a direction toward the center of the traveling lane.

CMBS is control that, when there is a possibility that the vehicle will collide with surrounding obstacles (other vehicles or pedestrians), warns the driver by display, alarm, or the like to call attention, and further, when the vehicle approaches an obstacle, executes at least one of steering control and acceleration/deceleration control to support collision avoidance and damage mitigation.

The judgment part 151 determines whether or not the driver is complying with a task imposed in the current driving mode based on the image of the driver monitor camera 70 and the detection result of the steering hold sensor 84. That is, the judgment part 151 monitors the state of the driver for mode change in the mode determination part 150, and determines whether or not the state of the driver is a state complying with the task.

For example, the judgment part 151 analyzes an image captured by the driver monitor camera 70, performs posture estimation processing, and determines whether or not the driver is in a posture incapable of shifting to manual driving in response to a request from the system. Furthermore, the judgment part 151 analyzes an image captured by the driver monitor camera 70, performs gaze estimation processing, and determines whether or not the driver is monitoring the front. The judgment part 151 determines whether or not the driver is holding the steering wheel 82 based on the detection result of the steering hold sensor 84.

When the judgment part 151 determines that the driver is not complying with a task imposed in the current driving mode, the execution part 152 sets an activation timing of an alarm based on driving characteristics and activates the alarm. That is, the execution part 152 sets an activation timing of an alarm by acquiring driving characteristics from the storage part 171 described later and activates the alarm at the activation timing.

Furthermore, the execution part 152 analyzes a reaction tendency of behavioral change of the driver after alarm activation. That is, the execution part 152 analyzes a reaction tendency of behavioral change of the driver after alarm activation based on the image of the driver monitor camera 70 and the detection result of the steering hold sensor 84 acquired from the judgment part 151.

The execution part 152 calculates an alarm occurrence frequency based on at least one of time and distance until the behavior of the driver changes by using alarm information acquired from the storage part 171.

The execution part 152 sets a threshold for alarm activation based on the alarm occurrence frequency. For example, the execution part 152 sets the threshold for alarm activation lower as the alarm occurrence frequency is higher. As a result, as the alarm occurrence frequency is higher, alarm activation is more likely to be performed, and the alarm is activated more frequently to the driver. The alarm occurrence frequency is an example of “driving characteristics”. The threshold for alarm activation is the time during which a task is not achieved. Lowering the threshold for alarm activation means that whereas an alarm is activated when a task is not achieved during a first time, the alarm is activated when a task is not achieved during a second time shorter than the first time.

When the execution part 152 analyzes that the driver's reaction of behavioral change tends to be slow, the execution part 152 makes a control timing or a control amount of at least one safe driving assistance function different from a normal control timing or control amount for the driver.

For a driver who ignores the alarm or does not respond to the alert, the execution part 152, for example, advances the control intervention timing for the collision mitigation brake (CMBS), reduces the steering return amount and increases the deceleration amount for the road departure mitigation function (RDM), and delays the response time of the required following speed for the preceding vehicle following control (ACC), and intervenes in control such as these.

When the judgment part 151 determines that the driver is not complying with a task imposed in the current driving mode, the execution part 152 executes control to switch from the current driving mode determined by the mode determination part 150 to a driving mode with restricted functions based on the presence or absence of behavioral change of the driver after alarm activation and the traveling situation around the vehicle recognized by the recognition part 130.

Furthermore, when the shift lever of the vehicle is operated by the driver and the shift lever is positioned in a non-traveling range or a reverse range, the execution part 152 releases the function restriction. That is, when the judgment part 151 determines that the driver is not complying with a task imposed in the current driving mode, the execution part 152 continues the function restriction until the vehicle stops traveling.

The second controller 160 controls the traveling driving force output device 200, the brake device 210, and the steering device 220 so that the vehicle passes through the target trajectory generated by the action plan generation part 140 at a scheduled time.

As shown in FIG. 2, the second controller 160 comprises, for example, an acquisition part 162, a speed controller 164, and a steering controller 166. The acquisition part 162 acquires information on the target trajectory (trajectory points) generated by the action plan generation part 140 and stores it in a memory (not shown). The speed controller 164 controls the traveling driving force output device 200 or the brake device 210 based on a speed element accompanying the target trajectory stored in the memory. The steering controller 166 controls the steering device 220 according to the degree of bending of the target trajectory stored in the memory. The processing of the speed controller 164 and the steering controller 166 is realized by, for example, a combination of feedforward control and feedback control. As an example, the steering controller 166 executes a combination of feedforward control according to the curvature of the road ahead of the vehicle and feedback control based on deviation from the target trajectory.

When performing driving assistance of the vehicle, that is, when the mode determination part 150 determines any one of mode A, mode B, or mode C as the driving mode, the driving assistance controller 170 controls one or both of acceleration/deceleration and steering of the vehicle by controlling the traveling driving force output device 200, the brake device 210, and the steering device 220.

The storage part 171 stores information related to driving characteristics of the driver. These driving characteristics relate to, for example, procedures and habits in the driver's vehicle operation. The storage part 171 provides information related to driving characteristics of the driver to the execution part 152 in response to a read request input from the execution part 152 described above.

The storage part 171 stores information related to alarms performed by the execution part 152 (alarm information) and information related to behavior of the driver after alarm activation (behavior information). The alarm information is, for example, the content of the alarm and the alarm occurrence frequency. The behavior information of the driver is, for example, information related to the driver's operation on the vehicle. The storage part 171 provides alarm information and information related to the behavior of the driver to the execution part 152 in response to a read request input from the execution part 152.

The traveling driving force output device 200 outputs traveling driving force (torque) for the vehicle to travel to drive wheels. The traveling driving force output device 200 comprises, for example, a combination of an internal combustion engine, an electric motor, a transmission, and the like, and an ECU (Electronic Controller) that controls these. The ECU controls the above configuration according to information input from the second controller 160 or information input from the driving operator 80.

The brake device 210 comprises, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the driving operator 80 so that brake torque corresponding to the braking operation is output to each wheel.

The brake device 210 may include a mechanism for transmitting hydraulic pressure generated by operation of a brake pedal included in the driving operator 80 to the cylinder via a master cylinder as a backup. Note that the brake device 210 is not limited to the configuration described above, and may be an electronically controlled hydraulic brake device that controls an actuator according to information input from the second controller 160 to transmit hydraulic pressure of the master cylinder to the cylinder.

The steering device 220 comprises, for example, a steering ECU and an electric motor. The electric motor, for example, applies force to a rack and pinion mechanism to change the direction of steered wheels. The steering ECU drives the electric motor according to information input from the second controller 160 or information input from the driving operator 80 to change the direction of the steered wheels.

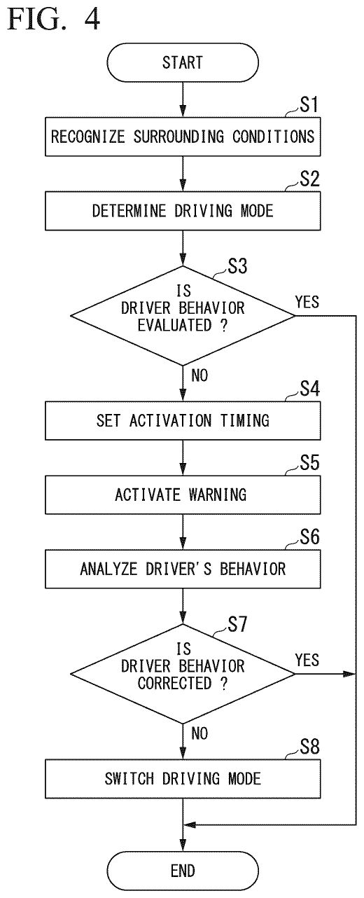

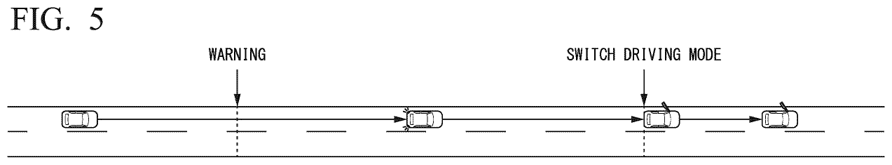

Next, the operation of the driving assistance device 100 according to the present embodiment, the driving assistance method, and the program will be described with reference to the flowchart of FIG. 4 and the schematic diagram of FIG. 5.

When the driving assistance device 100 starts driving assistance, the recognition part 130 of the first controller 120 recognizes the situation around the vehicle based on information input from the camera 10, the radar device 12, and the LIDAR 14 via the object recognition device 16 (step S1).

As shown in FIG. 3, the mode determination part 150 of the first controller 120 determines one driving mode from among a plurality of driving modes (modes A to E) in which driving states of the vehicle and tasks are associated (step S2). The mode determination part 150, for example, determines any one of mode B, mode C, or mode D as the driving mode when the control state is driving assistance. Step S2 may be executed before step S1.

When the driving mode is mode B, mode C, or mode D, the driving assistance controller 170 makes the vehicle travel with driving assistance by controlling the traveling driving force output device 200, the brake device 210, and the steering device 220. For example, when the driving mode is set to mode B, mode C, or mode D during traveling of the vehicle, the driving assistance controller 170 starts driving assistance control.

The judgment part 151 of the first controller 120 determines whether or not the driver is complying with a task imposed in the current driving mode (step S3). That is, the judgment part 151 determines whether or not the behavior of the driver is complying with a task imposed in the current driving mode based on the image of the driver monitor camera 70 and the detection result of the steering hold sensor 84 (performs behavior evaluation of the driver).

When the judgment part 151 determines that the driver is not complying with the imposed task, the execution part 152 of the first controller 120 first sets an activation timing of an alarm (step S4). That is, in this case, the execution part 152 acquires information related to driving characteristics of the driver from the storage part 171, and sets an activation timing based on the driving characteristics of the driver.

For example, information in which types of driving characteristics and activation timings are associated is stored in the storage part 171. An activation timing is set based on this information. For example, when the driving characteristics are pattern A, it is set as a first timing, and when the driving characteristics are pattern B, it is set to be a second timing. The execution part 152 sets an activation timing according to the driving characteristics of the driver. Note that the execution part 152 can recognize the driver based on identification information input by the driver, a face image registered in advance, a fingerprint set in advance, and the like, and identifies driving characteristics associated with the identification information of the driver.

When the setting of the activation timing of the alarm is completed in this way, the execution part 152 activates an alarm to the driver during traveling of the vehicle as shown in FIG. 5 (step S5). When the activation of the alarm is completed, the execution part 152 performs behavior analysis of the driver after alarm activation (step S6).

When the judgment part 151 determines that the behavior of the driver has not been corrected (step S7), the execution part 152 causes the mode determination part 150 to execute switching from the current driving mode to a driving mode with restricted functions during traveling of the vehicle as shown in FIG. 5 (step S8).

The mode determination part 150 switches the current driving mode to a driving mode with restricted functions based on a control instruction input from the execution part 152. Among mode B, mode C, or mode D, mode C is a driving mode in which functions are more restricted than mode B. Furthermore, mode D is a driving mode in which functions are more restricted than mode C.

For example, during driving assistance by mode B, when the judgment part 151 determines that the driver is not complying with a task imposed in mode B, the execution part 152 outputs a control instruction to switch mode B (current driving mode) that has already been determined to mode C to the mode determination part 150. As a result, the mode determination part 150 switches mode B (current driving mode) to mode C.

During driving assistance by mode C, when the judgment part 151 determines that the driver is not complying with a task imposed in mode C, the execution part 152 outputs a control instruction to switch mode C (current driving mode) that has already been determined to mode D to the mode determination part 150. As a result, the mode determination part 150 switches mode C (current driving mode) to mode D.

Note that, for example, in mode A, when the judgment part 151 determines that the driver is not complying with a task imposed in mode A, the execution part 152 may output a control instruction to switch mode A (current driving mode) that has already been determined to mode B to the mode determination part 150. As a result, the mode determination part 150 switches mode A (current driving mode) to mode B. The task in mode A is that the driver is in a posture incapable of shifting to manual driving in response to a request from the system (for example, continuing to look aside outside a permitted area from the image of the driver monitor camera 70, or a sign that driving becomes difficult is detected, etc.).

Note that the restriction of the driving assistance function by switching the current driving mode to a driving mode with restricted functions is released when the shift lever of the vehicle is positioned in the P range (parking range). That is, when the shift lever is positioned in a non-traveling range or a reverse range, the execution part 152 returns the driving mode with restricted functions to the driving mode that was set immediately before.

Note that in the above flowchart, the processing of performing behavior analysis of the driver in step S6 may be executed after the processing of one routine of the flowchart is completed. The execution part 152 analyzes a reaction tendency of behavioral change of the driver after alarm activation. Analyzing is, for example, analysis of reaction tendencies for each driving characteristic. For example, the execution part 152 derives by statistically processing the time from the alarm to performing the task for each pattern of driving characteristics, or analyzes the behavior of the driver after the alarm by analyzing the image and the operation content of the driver. For example, it is analyzed that a driver of driving characteristics pattern A performs an operation within a predetermined time, and a driver of driving characteristics pattern B does not understand a task required after the alarm. The analysis result may be provided to other devices. The execution part 152 may give advice to the driver based on the analysis result. The advice includes, for example, shortening the time from the alarm to performing the task by 5 seconds, or performing forward monitoring, which is a task after the alarm.

The execution part 152 may correct a threshold for alarm activation for each pattern of driving characteristics based on the result of the analysis. Thereby, in the next processing, alarm activation is performed using the corrected threshold. For example, assume that a driver of driving characteristics pattern 1 has executed a task after a first time after an alarm is given. The execution part 152 corrects so as to reduce the threshold for alarm activation of driving characteristics pattern 1. A reference time is associated with driving characteristics pattern 1 before correction, and this reference time is a time shorter than the first time. The driver of driving characteristics pattern 1 executed a task in response to the alarm after a time longer than the reference time has elapsed. In this way, for a driver who needs more alerting, the threshold is reduced and adjustment is made so that an alarm is given at an early timing. For example, assume that a driver of driving characteristics pattern 1 has executed a task after a second time after an alarm is given. The execution part 152 corrects so as to increase the threshold for alarm activation of driving characteristics pattern 1. The driver of driving characteristics pattern 1 executed a task in response to the alarm in a time shorter than the reference time. In this way, for a driver for whom the degree of alerting can be relaxed, the threshold is increased and adjustment is made so that an alarm is given at an appropriate timing.

Note that one or both of the reference time and threshold for each pattern of driving characteristics may be different or the same. Furthermore, when correcting the above threshold, the content of the correction may be different for each corresponding pattern of driving characteristics. For example, when driving characteristics pattern 1 has lower skills related to driving or a shorter driving history than driving characteristics pattern 2, the degree of correction of the threshold of pattern 1 may be made so that the timing of alarm activation is earlier than the degree of correction of the threshold of pattern 2.

As described above, the driving assistance device 100 according to the present embodiment comprises the recognition part 130 that recognizes a situation around a vehicle, the driving controller 170 that controls one or both of acceleration/deceleration and steering of the vehicle, the mode determination part 150 that determines a driving mode in which the vehicle travels in any one of a plurality of driving assistance modes in which tasks imposed on a driver of the vehicle differ, the judgment part 151 that determines whether or not the driver is complying with a task imposed on the driver, the storage part 171 that stores driving characteristics of the driver, and the execution part 152 that, when the judgment part 151 determines that the driver is not complying with the task, sets an activation timing of an alarm based on the driving characteristics of the driver and activates the alarm, wherein the execution part 152 analyzes a reaction tendency of behavioral change of the driver after alarm activation.

According to the present embodiment, based on driving characteristics of the driver (driving style, behavior pattern, driving skill, driving history, accident history, personality, near-miss/accident history, etc.), behavior of the driver after an alarm is activated once is analyzed, and the activation timing of the alarm can be adjusted according to whether or not the driver has an improvement tendency, so excessive operation of the alarm can be suppressed. According to such present embodiment, since a more appropriate alarm is performed than conventionally, it is possible to provide the driving assistance device 100 capable of suppressing misuse and abuse of automated driving functions more than conventionally.

The driving characteristics may include demographic information such as the gender, age, and region where the driver lives. Furthermore, the driving characteristics may include information indicating the emotion of the driver. The emotion of the driver is estimated by voice recognition processing from the facial expression of the driver, voice (intonation, strength, etc.), content of utterance, and the like The facial expression is estimated from an image captured by the driver monitor camera 70. Voice recognition processing is executed by sound picked up by a microphone mounted in the vehicle interior of the vehicle. The execution part 152, for example, estimates the emotion of the driver based on a preset algorithm using images and voices.

In the driving assistance device 100 according to the present embodiment, alarm information is stored in the storage part 171, and the execution part 152 sets a threshold for alarm activation based on an alarm occurrence frequency extracted from the alarm information. According to such present embodiment, for a driver suspected of misuse or abuse for whom an alarm is activated many times, the threshold for alarm activation is lowered, and the operation timing of a penalty is advanced as necessary to prompt correction of behavior, and for a single alarm activation due to a malfunction attributable to human error, guidance for prompting behavior improvement is notified so that the alarm does not occur frequently.

In the driving assistance device 100 according to the present embodiment, the judgment part 151 determines whether or not the behavior of the driver has been corrected after alarm activation. According to such present embodiment, since behavioral change of the driver after alerting by the alarm is determined, more appropriate alerting can be performed. Note that the above determination is performed by monitoring behavioral change before and after alarm activation with measuring instruments such as a driver monitor camera, a steering hold sensor, and a load sensor.

In the driving assistance device 100 according to the present embodiment, when the execution part 152 analyzes that the reaction of the behavioral change of the driver tends to be slow, the execution part 152 makes a control timing or a control amount of at least one safe driving assistance function different from a normal control timing or control amount for the driver.

According to such present embodiment, for a driver who ignores the alarm or does not respond to the alert, for example, in the case of a collision mitigation brake (CMBS), the control intervention timing may be advanced, and in the case of a road departure mitigation function (RDM), one or both of control to reduce the steering return amount and control to make the deceleration of the vehicle greater than normal may be performed. In the case of preceding vehicle following control (ACC), by intervening in control such as delaying the response time of the required following speed, since the fact that function restriction has been activated due to misuse is transmitted to the driver as a sense of discomfort different from the alarm, it helps to correct behavior.

In the driving assistance device 100 according to the present embodiment, the execution part 152 calculates an alarm occurrence frequency based on at least one of time and distance until the behavior of the driver changes. For example, the execution part 152 calculates the alarm occurrence frequency based on a target time from the alarm until a behavior in response to the alarm is performed and a target distance that the vehicle has traveled from the alarm until a behavior in response to the alarm is performed. For example, it is calculated as one occurrence per setting time or per setting distance. For example, when the target time is setting time×2, it is calculated as alarm occurrence frequency “2”, and for example, when the target distance is setting distance×2, it is calculated as alarm occurrence frequency “2”. According to such present embodiment, effective provision of alarms suited to the driver's characteristics, that is, the reaction time of behavioral change to the alarm and the movement distance until reaction, can be performed.

In the driving assistance device 100 according to the present embodiment, when it is determined that the driver is not complying with the task, the execution part 152 executes control to switch the current driving mode determined by the mode determination part 150 to a driving mode with restricted functions, and releases the function restriction when the shift lever of the vehicle is positioned in a non-traveling range or a reverse range. According to such present embodiment, by intentionally requiring a complicated operation to release the function restriction, there is an effect of psychologically suppressing misuse and abuse of the safe driving assistance function.

More specifically, when the driver operates the shift position to the P range, the system (controller) recognizes that driver handover has occurred or that driving has been temporarily stopped, thereby automatically releasing the function restriction, and the function restriction may be automatically released by operating the shift position from the D range to the R range or N range in which the drive output mode of the traveling driving force output device is greatly switched for a predetermined time.

The driving assistance method according to the present embodiment recognizes a situation around a vehicle, controls one or both of acceleration/deceleration and steering of the vehicle, determines a driving mode in which the vehicle travels in any one of a plurality of driving assistance modes in which tasks imposed on a driver of the vehicle differ, determines whether or not the driver is complying with a task imposed on the driver, stores driving characteristics of the driver, when it is determined that the driver is not complying with the task, sets an activation timing of an alarm based on the driving characteristics and activates the alarm, and analyzes a reaction tendency of behavioral change of the driver after alarm activation. According to such present embodiment, since a more appropriate alarm is performed than conventionally, it is possible to provide a driving assistance method capable of suppressing misuse and abuse of automated driving functions more than conventionally.

The program according to the present embodiment causes a computer to recognize a situation around a vehicle, control one or both of acceleration/deceleration and steering of the vehicle, determine a driving mode in which the vehicle travels in any one of a plurality of driving assistance modes in which tasks imposed on a driver of the vehicle differ, determine whether or not the driver is complying with a task imposed on the driver, store driving characteristics of the driver, when it is determined that the driver is not complying with the task, set an activation timing of an alarm based on the driving characteristics and activate the alarm, and analyze a reaction tendency of behavioral change of the driver after alarm activation. According to such present embodiment, since a more appropriate alarm is performed than conventionally, it is possible to provide a program capable of suppressing misuse and abuse of automated driving functions more than conventionally.

The embodiments of the present invention have been described above, but the present invention is not limited to the above embodiments. Various modifications and substitutions can be added without departing from the gist of the present invention. For example, the device configuration shown in FIGS. 1 and 2 is merely an example of the present invention, and various modifications are conceivable.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

100 Driving assistance device
120 First controller
130 Recognition part
150 Mode determination part
151 Judgment part
152 Execution part
160 Second controller
170 Driving assistance controller
171 Storage part

What is claimed is:

1. A driving assistance device comprising:
a recognition part that recognizes a situation around a vehicle;
a driving controller that controls one or both of acceleration/deceleration and steering of the vehicle;
a mode determination part that determines a driving mode in which the vehicle travels in any one of a plurality of driving assistance modes in which tasks imposed on a driver of the vehicle differ;
a judgment part that determines whether or not the driver is complying with a task imposed on the driver;
a storage part that stores driving characteristics of the driver; and
an execution part that, when the judgment part determines that the driver is not complying with the task, sets an activation timing of an alarm based on the driving characteristics and activates the alarm,
wherein the execution part analyzes a reaction tendency of behavioral change of the driver after alarm activation.

2. The driving assistance device according to claim 1, wherein
alarm information is stored in the storage part, and
the execution part sets a threshold for alarm activation based on an alarm occurrence frequency extracted from the alarm information.

3. The driving assistance device according to claim 1, wherein
the judgment part determines whether or not behavior of the driver has been corrected after alarm activation.

4. The driving assistance device according to claim 1, wherein
when the execution part analyzes that a reaction of the behavioral change tends to be slow, the execution part makes a control timing or a control amount of at least one safe driving assistance function different from a normal control timing or control amount for the driver.

5. The driving assistance device according to claim 2, wherein
the execution part calculates the alarm occurrence frequency based on at least one of time and distance until behavior of the driver changes.

6. The driving assistance device according to claim 1, wherein
when it is determined that the driver is not complying with the task, the execution part executes control to switch a driving mode determined by the mode determination part to a driving mode with restricted functions, and releases the function restriction when a shift lever is positioned in a non-traveling range or a reverse range.

7. A driving assistance method in which a computer
recognizes a situation around a vehicle,
controls one or both of acceleration/deceleration and steering of the vehicle,
determines a driving mode in which the vehicle travels in any one of a plurality of driving assistance modes in which tasks imposed on a driver of the vehicle differ,
determines whether or not the driver is complying with a task imposed on the driver,
stores driving characteristics of the driver,
when it is determined that the driver is not complying with the task, sets an activation timing of an alarm based on the driving characteristics and activates the alarm, and
analyzes a reaction tendency of behavioral change of the driver after alarm activation.

8. A program that causes a computer to
recognize a situation around a vehicle,
control one or both of acceleration/deceleration and steering of the vehicle,
determine a driving mode in which the vehicle travels in any one of a plurality of driving assistance modes in which tasks imposed on a driver of the vehicle differ,
determine whether or not the driver is complying with a task imposed on the driver,
store driving characteristics of the driver,
when it is determined that the driver is not complying with the task, set an activation timing of an alarm based on the driving characteristics and activate the alarm, and
analyze a reaction tendency of behavioral change of the driver after alarm activation.
